(19) United States
(12) Patent Application Publication
(10) Pub. No.: US 2023/0123743 A1
(43) Pub. Date: Apr. 20, 2023

(54) METHOD AND APPARATUS FOR PRECISE CONTROL OF ENERGY DELIVERY IN OPTICAL SCANNING DEVICES

(71) Applicant: charles bibas, great neck, NY (US)

(72) Inventor: charles bibas, great neck, NY (US)

(21) Appl. No.: 17/958,358

(22) Filed: Oct. 1, 2022

Related U.S. Application Data
(60) Provisional application No. 63/251,460, filed on Oct. 1, 2021.

(51) Int. Cl. B23K 26/70

(52) U.S. Cl. CPC B23K 26/705

(57) ABSTRACT

An invention for 2D and/or 3D scanning devices. The invention discloses a method and an apparatus for precise control and regulation of laser processing in order to provide a desired energy density delivered by the scanner across the work surface for printing and/or sensing applications.

### CROSS REFERENCE TO RELATED APPLICATIONS

This application incorporates by reference and claims priority to and the benefit of US Provisional Pat. Application serial. No. US63/251,460 with filing or 371(c) date of Oct. 01, 2021.

### FIELD OF INVENTION

The present invention relates to a beam director, directing light for modulation of energy intensity, using multiple reflectors, suited specifically for 2D and 3D scanners as well as printers.

### BACKGROUND

Traditional Scanners (TS) such as galvanometers or polygonal scanners use moving mirrors to direct a laser beam. The scan lines when on the work surface need to be in focus, at a constant speed, with constant Optical Path Length (OPL), This ensures deliver/receive consistent energy to the pixel/voxel under test during the scan to allow for consistent and reliable scanning. TS suffers from a change of energy delivered or received from the scan pixel/voxel. Additionally, the TS system design is based on multiple lenses adding lens-related errors and tradeoffs. To mitigate the non-constant speed, the TS is using f-theta lens. To correct telecentricity the TS may be using a telecentric lens, since the focus of the beam in the TS is on about a sphere a flat field lens is used to flatten the focus plane to a flat plane by using a flat field lens. As a result, multiple lenses are needed to mitigate the symptoms. Since the solution cannot deliver a fix for each problem, tradeoffs are used by the lens manufacturer when delivering the lens.

Using a beam director for surface and subsurface scanning (BDSS) will deliver consistent energy by keeping the beam speed, size, and shape consistent across the scan line.

The introduction of a beam director as described in US Patents US10,473,915, US10,416,444, US9,435,998 opened up new applications in the field of medicine, art, archeology, and document inspection. As it can be used for surface and subsurface scanners (BDSS) The BDSS core function is based on mirrors and the reduction of the number of devices along the optical axis, thus improving and simplifying the scanning process.

In Metal 3D printing one of the main obstacles in the process is controlling the temperature of the part and the printed layer constant during the process of printing. Because of the high heat conductivity of metals, the heated area is much larger than the laser beam diameter and it is quantified by a grid to create hatches. Using hatches gives the user the ability to control the heat by running on a Grid from one hand and losing resolution from the other hand.

Most of the lasers used in 3D printing in the industry are gaussian beam lasers. Where a gaussian beam is more challenging, therefore requires higher metal conductivity; limiting the number of metals that can be used.The industry is dealing with this temperature prediction process by using AI supported by monitoring sensors in an attempt to mitigate the problem.

Energy delivery refs:
JOM Journal - Quantifying energy for legacy galvo delivery
https://us02web.zoom.us/j/85318119293?pwd=aFRkYnZwNTdMNzhxNFNaTFJh c1pRZz09

### SUMMARY OF THE INVENTION

The present invention deals with scanning of an area where the scans are composed of a plural number of laser lines or vectors (“scan lines”). When two scan lines or more are close to each other the energy density is calculated based on each scan line properties and the proximity of distance between the scan lines. In this invention, the process of calculating the total energy delivered/received is simplified by calculating the number of pixels/voxels per unit area. As an example, two parallel lines with the same optical properties will be delivering a consistent energy as the number of trapped pixels/voxels per unit are constant.

The present invention recognizes that typical utilization of multiple reflecting surfaces as beam directors changes the characteristics of the final beam; shape, intensity and focus. In selective laser sintering (SLS) and selective laser melting (SLM), printing is controlled by a moving beam produced by a galvanometer (GS) or a polygonal mirror (PM) setup. As the beam moves across the work plane, the energy deposited into each voxel varies because of the changes in the incidence angle and the beam size of the GS / PM beam.

The applicant proposes multiple methods to uniformly deposit energy onto the work surface using specifically the Øgon™ (ZERO-gon) also known as Lens Free Optical Scanner (LFOS) 3D scanner, thereby overcoming the drawbacks encountered with the GS and PM scanning setups. The scan lines for the LFOS composed of arcs with radius R. When an arc scan line is moving by a delta distance the proximity between two adjacent arcs, the distance between the arcs get closer to each other as it is measured further away from the moving line of the delta distance as in FIG. 4.

In one embodiment of this invention, the entire Øgon™ printing setup consists of a two main reflective surfaces; the primary and the secondary reflector. The primary reflector rotates around an axis with the rotation velocities adjustable as per application requirements. The incident light on the primary reflector is reflected on to the secondary curved reflector before eventually striking on the work plane, located beneath the entire reflector setup.. The second reflector reflects the beam to the work surface tracing a circular arc.

In another embodiment of this invention, a method for uniformly setting the incident laser power on the work plane is presented. Instead of providing equal power, depending on the position of the pixel on the work plane arc, the laser power is modulated by either adjusting the incident ray amplitudes or by varying the exposure times.

In yet another embodiment of this invention, work plane is divided into layers which are further sub divided into multiple hatches. By using a constant power for the incident laser, the size of the individual hatches is varied to ensure the overall power density through the work plane remains constant. This embodiment applies but is not limited to printed materials with high heat conductivity such as metals.

In one final embodiment of this invention, the rotational speed of the primary reflector is varied as the beam scans towards the edge of the work plane. Varying the rotational velocity of the primary reflector changes the incident power of the laser on the work surface, thus enabling uniform power delivery.

These and other embodiments and advantages of the invention herein and summary will become readily apparent from the following detailed description taken in conjunction with the accompanying drawings.

### BRIEF DESCRIPTION OF DRAWINGS

The patent or application file contains at least one drawing executed in color. Copies of this patent or patent application publication with color drawing(s) will be provided by the Office upon request and payment of the necessary fee.

A more precise appreciation of the disclosure and many of the attendant advantages thereof will be readily obtained as the same becomes better understood by reference to the following detailed description when considered in connection with the accompanying drawings, wherein:

FIG. 1 shows an image of the complete Øgon™ 3-D scanning setup.

FIG. 2(a) shows the reflector arrangement of the Øgon™ print head.

FIG. 2(b) shows the main reflector mounting on a stabilizing jacket

FIG. 3 shows the beam size changes in the local x, y coordinates as the beam travels along the optical axis.

FIG. 4 shows the multiple arcs as sketched on the work plane.

FIG. 5 shows the geometrical view of neighboring pixels.

FIG. 6 shows the energy intensity as a function of the arc opening angle β.

[24] FIG. 7 shows the parallelogram created by four pixels from two neighboring arcs.

### DETAILED DESCRIPTION

Subject matter will now be described fully hereinafter with reference to the accompanying drawings, which form a part hereof, and which show, by way of illustration, specific exemplary embodiments and performance metrics. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonable broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration”. Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an”, and “the” are intended to include the plural forms as well, unless the context indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

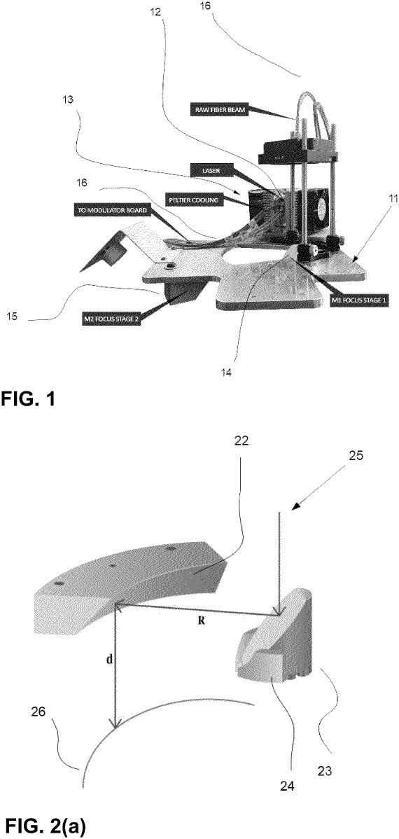

The Øgon™ 3D scanner, as installed in the final form, is shown in FIG. 1 rigid frame 11 supports a laser light source 12, a cooling setup 13, the primary reflector (M1) 14, and the secondary reflector (M2) 15. Cables 16 run from the modulator circuit onto the laser light source to induce any modulation as desired. The entire structure of FIG. 1 is installed at a fixed height above the work plane. By installing a suitable vertical mobility mechanism, the Øgon™ setup can be moved vertically to scan larger objects as required.

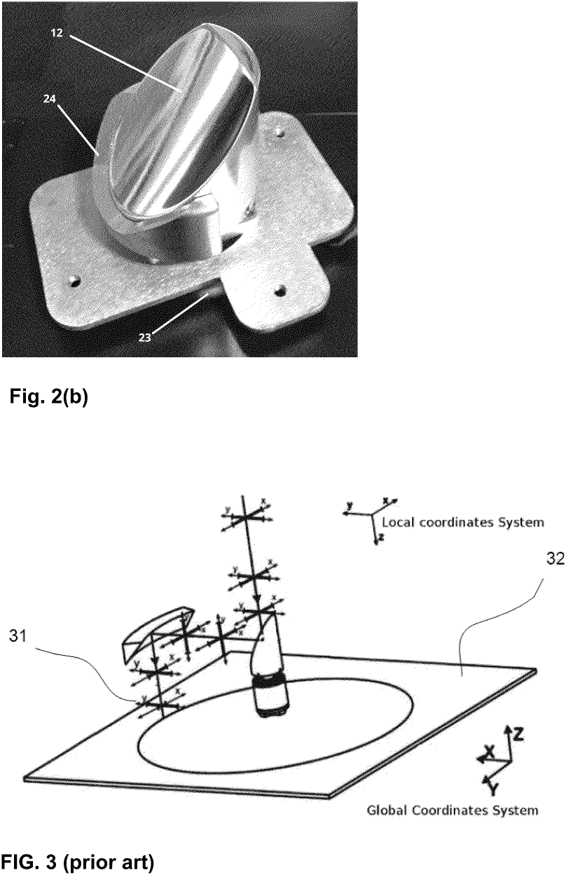

The print head of the Øgon™ comprises the primary reflector (M1) 21 and a curved secondary reflector (M2) 22 installed on a motor 23 as shown in FIG. 2(a) A stabilizing jacket 24 surrounds the bottom part of M1 21 to keep the center of mass of the combined M1 21 and the stabilizing jacket along the optical axis, which is also the rotational axis of M1 21, of the structure. This installation enables the primary reflector M1 21 to rotate wiggle free and is possible only due to the counter weight of the stabilizing jacket, made usually of stainless steel or an alternate suitable material. While in operation, M1 21 rotates around its axis reflecting the incident light ray 25 on to M2 22. By virtue of its construction, M2 22 reflects the light ray downwards onto the work plane. Due to the constant rotation of M1 21 around its axis, the light ray scans an arc 26 on the work plane. By the combined movement of the M1 21 and M2 22 assembly in a straight line in the horizontal plane, the entire work plane can be scanned. An actual installation of M1 21 with the stabilizing jacket 24 is shown in FIG. 2(b).

The Øgon™ uses a modified raster scanning method in which the x-axis (as depicted in FIG. 3) is scanned in arcs instead of horizontal lines. After each arc, a linear conveyor moves the ØgonTM a fixed vertical distance along the y-axis to scan the next arc. The radius of each arc is R, the distance between M1 21 and M2 22. As the rotational speed of M1 21 is constant, the pixel locations on each arc are dictated by a constant time interval between them. This direct modulation ensures a linear mapping of the pixels on to the work plane. This method resembles polygonal mirror (PM) 2D printing. However, the result is much superior to the PM scanning method because the PM must print on a cylindrical conveyor to keep the focus, while the Øgon™ is at focus even when printing on a flat surface. Additionally, the slow-moving conveyor wear and tear is very small compared, for example, to a CNC actuator because there is very little travel time for the Øgon™ print.

For additive manufacturing applications, information is compiled by slicing the design into layers and then rendering each layer with arcs. Each layer data is saved in an array; layer rendering information is contained in a two-dimensional array Arc[i][j] where i is the arc number and j represents a pixel within the arc. The modulation for this case is performed by turning the laser beam on or off with a set time interval between the voxels. For precise control of energy deposition, the ØgonTM laser energy output can be modulated by pulse width and/or analog intensity for each voxel.

Referring to FIG. 3, since beam 31, when incident on the work plane 32, is perpendicular to the work plane 32, the beam path at the work plane 32 follows the M2 22 curvature radius R. Beam location along each arc can be expressed simply using polar coordinates as:

| Arc Length, s (β) = R▪β, or alternatively | (1) |
|---|---|
| s(t) = 2▪π▪R▪ƒ▪t | (2) |

where β is the beam location, and f is the rotational frequency of M1 21.

The scanning of the Øgon™ is done by using a linear conveyor mechanism to scan between arcs. The beam position on the work plane in Cartesian coordinates can be expressed as:

| x (t) = R•sin (2•π▪ƒ•t) | (3) |
|---|---|
| y(t) = Y_{c}(t) + R•cos (2•π•ƒ•t) where Y_{c}(t) is the conveyor location at any given time t. | (4) |

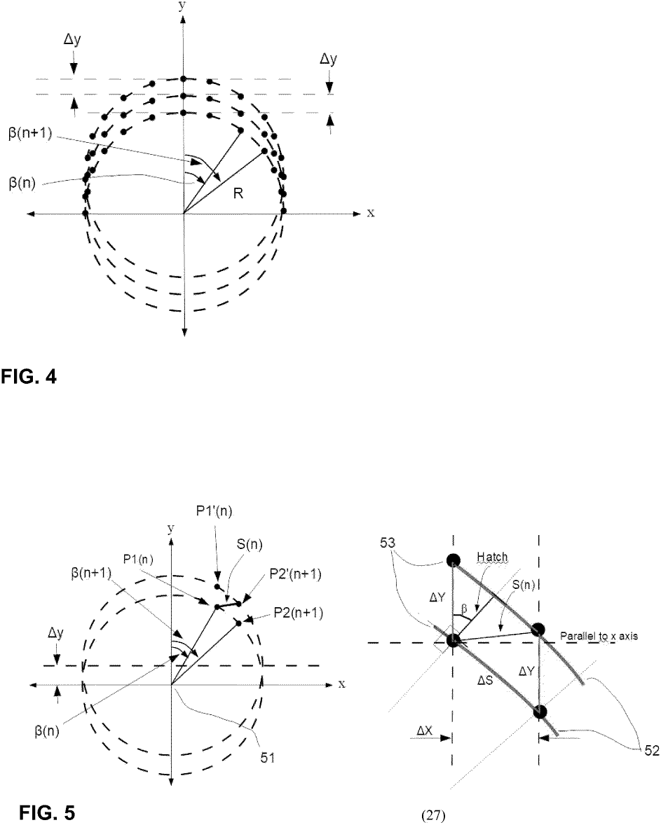

Alternatively, the beam location on the work plane 32 can be expressed as a function of the arc number i and the pixel location j on any given arc i (as shown in FIG. 4) as:

| x (j) = $R ⋅ s i n \left(2 ⋅ π ⋅ \frac{j}{P}\right)$ | (5) |
|---|---|
| y(i, j) =i▪Δy+ $R ⋅ cos c o s \left(2 ⋅ π ⋅ \frac{j}{P}\right)$ where Δy defines the change of position of Øgon™ as the conveyor moves in the y-axis, and P is the total number of pixels in a full circle. | (6) |

Considering the pixel geometry shown in FIG. 5, with the beam speed and the diameter constant, as the angle β (angular deflection from the center of the arc 51) increases, the spacing D between the adjacent arcs 52, also known as the hatch distance, decreases, thereby increasing the total number of pixels 53 per unit area. Geometrically, the hatch distance can be expressed as:

| Hatch = D •β Alternatively, as a function of pixel location i and the total number of pixels P, | (7) |
|---|---|
| Hatch = $D ⋅ c o s \left(2 ⋅ π ⋅ \frac{i}{P}\right)$ | (8) |

The energy density of the i th pixel on any given arc can be mathematically expressed as:

| | |
|---|---|
| $\begin{matrix}{E}_{v i} = \frac{{P}_{i}}{v ⋅ {L}_{h} ⋅ D ⋅ cos \left(2 ⋅ π ⋅ \frac{i}{p}\right)} \\ = \frac{{P}_{i}}{2 ⋅ π ⋅ R ⋅ f ⋅ {L}_{h} ⋅ D ⋅ \text{cos} \left(2 ⋅ π ⋅ \frac{i}{p}\right)} \\ = \frac{{E}_{v 0}}{cos \left(2 ⋅ π ⋅ \frac{i}{p}\right)}\end{matrix}$ Alternatively, as a function of β, the energy density can be expressed as: | (9) |
| ${E}_{v} ( β ) = \frac{{E}_{v 0}}{cos ( β )}$ | (10) |

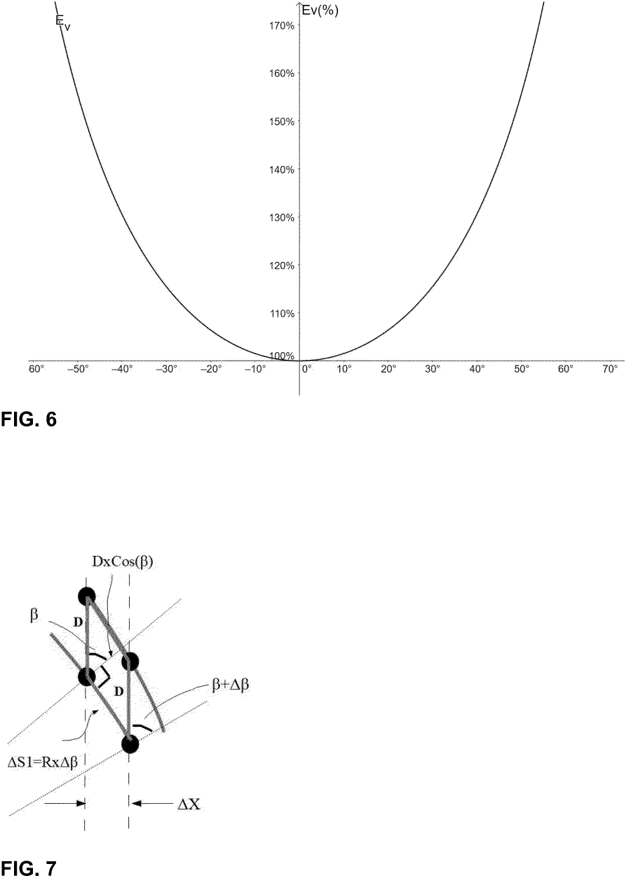

FIG. 6 shows the energy density of Eq. 10 as a function of the angle β. It is clearly evident that as β increases, the energy density starts to increase. As an illustration, for an opening (β) of ± 30°, the energy density shows an increase of about 14%, eventually due to the increase in the pixel density as explained earlier.

The laser power for the i th pixel can be calculated as:

| | |
|---|---|
| ${P}_{l i} = {P}_{l 0} ⋅ cos \left(2 ⋅ π ⋅ \frac{i}{p}\right)$ where P₁₀ represents the laser power at the center (β = 0) of the arc. | (11) |

The first method of uniform power delivery provided by this invention involves adjusting the individual pixel power as per Eq. 11. By either amplitude modulating the Pₗ signal, or, by prolonging the exposure time of the laser for any particular pixel, the power can be adjusted to remain constant for all the pixels on any given arc.

The second method of power delivery relies on slicing each individual layer into arcs, resulting in a simpler mathematical analysis. Considering the four neighboring pixels 53 on two adjacent arcs 52 as shown in FIG. 5, the closed parallelogram formed between the said pixels constitutes an area, which, for the i th parallelogram, can be mathematically expressed as:

| | | |
|---|---|---|
| where, | ΔA₀ = ΔAᵢ = ΔSᵢ • Hatchᵢ | (12) |
| $Δ {S}_{i} = \frac{Δ {A}_{0}}{H a t c {h}_{i}} = \frac{2 ⋅ π ⋅ R ⋅ \frac{1}{P}}{cos \left(2 ⋅ π ⋅ \frac{i}{p}\right)}$ | | (13) |

The slicing strategy of Eq. 13 relies on subdividing each layer into parallelograms with different areas while keeping the laser power constant. Such an approach would utilize a slicing algorithm to actively slice and define the areas on the work plane and operate the laser accordingly.

The third method to ensure uniform energy density involves slicing chords parallel to the x-axis as shown in FIG. 7. The distance between the chords Δy is adjusted to keep Δx constant, keeping constant energy density. Due to varying Δy, the spacing of each individual pixel on the arc keeps changing, while the laser power remains constant.

The fourth and final method to deliver uniform energy required modifying the rotational speed of M1 21 to accommodate for the increase in energy density. Mathematically the rotational speed can be expressed as:

| | |
|---|---|
| $v = {v}_{0} ⋅ \frac{1}{cos \left(2 ⋅ π ⋅ \frac{i}{p}\right)}$ | (12) |

By varying the rotational speed of M1 21, in accordance with Eq. 9 and Eq. 10, the energy density can be made constant by keeping the other factors intact.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiments, methods, and examples, but by all embodiments within the scope and spirit of the invention as claimed.

What is claimed is:

1. A beam director unit comprising of;
a configurable controller to maintain a desired energy density on calculated positions on the work plane by controlling the laser power and exposure time on the laser path.

2. The configurable controller of claim 1 further comprising of;
a pixel density calculation of a single path or more paths for keeping a desired power level per unit area.

3. The configurable controller of claim 2 further comprising of;
a pixel density calculation on an arc or plurality of arcs paths, spaced by a distance D from the center of the arcs, to ensure the power level per unit area at a set desired power level for all the adjacent arcs.

4. A method of performing the calculation as per claim 3 further comprising of;
determining the total number of plurality of pixels P on the worksurface based on the application and size of the scanning / printing problem;
identifying and keeping a record of the physical position of every individual pixel (i) on every individual scanning arc;
during the scanning process, based on the current position of the laser light on the work plane, calculating the laser power required for the next individual pixel on the arc so as to ensure uniform energy density for each print line utilizing the formula characterized by the relation:
${P}_{l i} = {P}_{l 0} ⋅ c o s \left(2 ⋅ \text{π} ⋅ \frac{i}{P}\right)$ where Pₗ₀ represents the laser power at the center (i, β = 0) of the arc; and
output power adjustment of the laser source based on the individual pixel power as calculated.

5. An alternate method of performing the calculation of claim 3 further comprising of;
decomposing the complete scan area into plurality of layers, wherein each layers consists of individual arcs (i);
depending on the size of the scan area, fixing the total number of pixels P per arc;
based on the total number of pixels, P, as required, marking and defining virtual areas bounded by a number of pixels; and
determining the mutual distances between adjacent pixels characterized by the relation:
$$Δ {S}_{i} = \frac{Δ {A}_{0}}{H a t c {h}_{i}} = \frac{2 ⋅ \text{π} ⋅ R ⋅ \frac{i}{P}}{c o s \left(2 ⋅ \text{π} ⋅ \frac{i}{P}\right)}$$
where R is the radius of curvature of the secondary reflector for a multi-reflector beam director system, and i is the index; and
adjusting the laser striking points on the work plane depending on the mutual distances between adjacent pixels, ΔSᵢ as calculated in the previous step, while keeping the incident laser power constant.

6. Another method of performing the calculation of claim 3 further comprising of;
slicing multiple parallel chords in the x-axis;
calculating the distance between pixels on adjacent arcs (Δy) to maintain a constant distance between adjacent pixels on the same arc (Δx); and
scanning the work plane in arcs with the pixels as well as the inter-arc separation as defined by the process in the previous step, while keeping the laser power constant.

7. A yet another method of performing the calculation of claim 3, for a multi-reflector system with at least one primary rotating reflector, further comprising of;
varying the rotational speed of the primary reflector as characterized by the following equation:
$$v = {v}_{0} ⋅ \frac{1}{c o s \left(2 ⋅ \text{π} ⋅ \frac{i}{P}\right)}$$
where P is the total number of pixels on any given arc, v₀ is the reference rotational speed of the primary reflector at i=0, i is the pixel index, and P is the incident power;
determining the individual laser energy required for any particular i th pixel on the arc by using the following equation:
$$\begin{matrix}{E}_{v i} = \frac{{P}_{i}}{v ⋅ {L}_{h} ⋅ D ⋅ c o s \left(2 ⋅ \text{π} ⋅ \frac{i}{P}\right)} = \\ \frac{{P}_{i}}{2 ⋅ \text{π} ⋅ R ⋅ f ⋅ {L}_{h} ⋅ D ⋅ c o s \left(2 ⋅ \text{π} ⋅ \frac{1}{P}\right)} = \frac{{E}_{v 0}}{c o s \left(2 ⋅ \text{π} ⋅ \frac{i}{P}\right)} = \frac{{E}_{v 0}}{c o s \left(\text{β}\right)}\end{matrix}$$
where Eᵥ₀ is the incident energy at the center of the work plane, Lₕ is the layer thickness, and f is the number of rotations per second of the primary reflector; and
using a mechanism to vary the laser power on every individual pixel on any given arc as determined by the steps before.

8. The beam director of claim 1, further comprising of;
a plurality of rotating reflecting surfaces with at least one primary reflector having its axis of rotation in line with the incident laser path; and
a rigid stabilizing enclosure surrounding the bottom part of the rotating reflector to eliminate any undesired vibrations / oscillations that may occur as the reflector rotates about its axis.

9. The beam director of claim 8 wherein the stabilizing enclosure mass distribution equalizes the rotating reflector mass resulting in a common center, along the rotational axis of the reflector, of the combined mass of the stabilizing structure along with the reflector.
